(19) United States
(12) Patent Application Publication
(10) Pub. No.: US 2010/0182264 A1
(43) Pub. Date: Jul. 22, 2010

(54) Mobile Device Equipped With Touch Screen

(75) Inventors: David Hahn, Seoul (KR); YoungEun Lee, Seoul (KR); JiHoon Lee, Seoul (KR)

Correspondence Address: PROCOPIO, CORY, HARGREAVES & SAVITCH LLP, 525 B STREET, SUITE 2200, SAN DIEGO, CA, 92101, US

(73) Assignee: Vanilla Breeze Co. Ltd., Seoul (KR)

(21) Appl. No.: 12/676,552

(22) PCT Filed: Jul. 25, 2008
(86) PCT No.: PCT/KR2008/004378

§ 371 Date: Mar. 15, 2010

(30) Foreign Application Priority Data
Sep. 10, 2007 (KR) 10-2007-0091355

(51) Int. Cl. G06F 3/041

(52) U.S. Cl. 345/173

(57) ABSTRACT

The present invention relates to the touch-screen mobile device provides a better user experience by enabling a true one-hand operation, as the user can hold the mobile device with one hand and operate the device with the thumb of the same hand. The present invention is comprising: a touch screen; an arc-shaped user interface, displayed on the touch screen, which takes one corner of the touch screen as its center; and a control part that detects user' touch actions such as tap, multiple-taps, swipe, drag, or hold & drag, and processes the user' feedback accordingly.

### TECHNICAL FIELD

The present invention relates to a mobile device equipped with a touch screen and more particularly to a mobile device equipped with a touch screen where a user can easily interact with the device by holding the mobile device with one hand and moving the thumb of same hand.

### BACKGROUND ART

Although the first notebook computer was introduced to the market only few decades ago, the electronic appliances are evolving at a phenomenal speed and becoming more compact and mobile as time passes by. Especially, with the trend of downsizing, people are responding greatly to PDA (Personal Digital Assistants) that store and display numerous data on the road. Also, mobile phone that takes form of smart phone is widely introduced to the market reflecting the recent trend of convergence. In addition, the notebook computer is being classified into as sub-notebook and mini notebook according to its size and it has even been upgraded to new type called UMPC (Ultra Mobile Personal Computer) recently.

In the case of PDA and UMPC (hereafter referred to as mobile device), a touch-screen interface, often with a stylus pen, is widely accepted for taking its input and generating its output. With the introduction of such mobile device equipped with a touch screen instead of keyboard to reduce the size, input method has dramatically been changed. For the text input method using such stylus pen, on-screen keyboard (also known as virtual keyboard) or specialized stroke based alphabet interface, e.g., Graffiti or hand writing recognition techniques are used to convert pen strokes into digital data.

However, in regards to previous methods, it was bothersome hold the mobile device on one hand and use the other hand to pick up a stylus pen and take input action for even a simple operation Therefore, an improvement of user interface that makes possible more intuitive input was necessary. Especially, the human engineering or ergonomic approach considering the weight and size of device was necessary with the characteristics of mobile device where a user operates the device while holding it with his hand.

### DISCLOSURE OF INVENTION

### Technical Problem

The present invention is devised to solve the problems of previous technology where a user can easily feed in data just by holding a mobile device and then steering the thumb left or right with the touch sensor pressed.

### Technical Solution

The present invention is characterized by a mobile device equipped with; A touch screen; A user interface displayed on the touch screen whose area is circumferenced by a corner of the touch screen and the boundary reachable by the user's thumb; and A control part that processes and responds to actions such as touch and drag on the screen surface.

In order to overcome the aforementioned problems, an applied example of the present invention can be further developed into a touch-screen device with; An arc-shaped user interface displayed on a corner of the touch screen; and A control part that controls the playback of multimedia contents wherein the control part controls the playback speed and direction of multimedia contents according to the direction, distance and speed of the user's finger movement when the contact is maintained on the touch screen along the specified area of the graphical user interface.

As another application to facilitate easy navigation and function selections within or across menus, the present invention is characterized by a touch-screen mobile device with: An arc-shaped user interface displayed on a corner of the touch screen, capable of tracing the movement of user's thumb after the user has firmly grabbed the device; and A control part that reacts to user's actions such as tap, multiple-taps, swipe, drag, or hold & drag and processes user's feedback. As an example, holding & dragging up or down with user's thumb on the boundary of the user interface will result in changing the focus within multiple lines of text or images.

### Advantageous Effects

With the aid of the present invention, a user can easily feed in data just by grabbing a mobile device on one hand and then moving the thumb of the same hand. Therefore, it has effect of not only preventing an accidental drop of the device since the posture to hold the mobile device is stable, but also enabling true one-hand operation of feeding in information that was not possible where a user had to hold a mobile device with one hand and key in information using stylus pen with the other hand.

### BRIEF DESCRIPTION OF THE DRAWINGS

FIG. 1 is an example of the mobile device according to the present invention,

FIG. 2 illustrates how to key in data to the touch-enabled mobile device for multimedia contents playback and controls.

FIG. 3 illustrates another method of feeding in data to the touch-screen based mobile device for menu navigation and function controls.

### BEST MODE FOR CARRYING OUT THE INVENTION

In accordance with the embodiment of the invention, a mobile device equipped with a touch screen consists of the followings as illustrated.

A mobile device equipped with a touch screen (110);

A user interface (120) displayed on the touch screen;

A control part (130).

The touch screen (110) displays the graphic or text data, measures the coordinates when physical contact on screen is detected with a stylus pen or a fingertip of the user. The touch screen, thus, serves as both an input device as well as an output device. For this invention, any commercially available touch screen can be utilized, and there is no restriction in shape as long as the user interface (120) can be displayed on one corner of the screen.

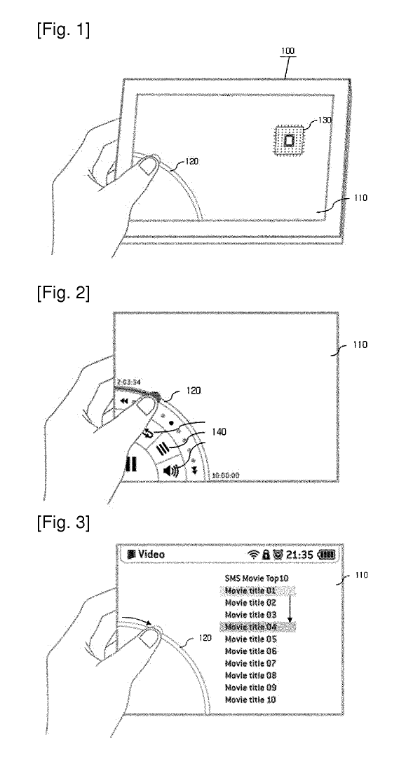

The user interface (120) is displayed at one corner of the touch screen (110) as illustrated in FIG. 1. To ensure an ergonomic operation with a user's thumb, the user interface operates along the quarter circle perimeter away from one corner of the touch screen (110) as its center. According to FIG. 1, for example, the user interface (120) is displayed at the bottom left corner of the touch screen (110), where the left and the bottom sides of the touch screen (110) and the user interface (120) form a fan shape.

While the user interface (120) closely resembles a fan shape as mentioned earlier, it is mainly for ergonomic and usability reasons where user's thumb can be reached and moved without much effort with the mobile device (100) held in the user's palm. Therefore, it does not restrict itself to have a geometrically perfect quarter circled shape or set the corner of touch screen as the center of the pivotal point. Instead, a shape that resembles either functionally or physically to a trail of paths that can be naturally drawn with a thumb while the mobile device (100) is securely held with the same hand will be considered enough fit. For this, a radius of the interface (120) is recommended to be between 2 and 6 cm.

In addition, the control part (130) performs certain processes corresponding to inputs through the user interface (120). Although FIG. 1 illustrates the control part (130) in form of IC to help understand, it can be implemented in form of Operational System that is not tangible. If the control part is implemented as a piece of hardware, it can be equipped inside the product so that it cannot be observed from the outside.

As illustrated in FIG. 1, the fan-shaped boundary of the user interface (120) descends from left to right. This curved line can be divided into multiple sections where certain processes can be performed corresponding to the user'a fingertap or hold & drag actions within or across the sections of the user interface (120). For example, top left portion of the interface can be set to rewind function, where the center portion is set to playback and pause, and the bottom right portion to fast forward function.

Certain other processes may be performed corresponding to the moving direction, distance and/or speed of the contact point on the user interface (120) when a user touches and drags with a thumb on it. For example, FIG. 3 illustrates a user steering thumb of left hand to the bottom right while touching the user interface (120) of the touch screen (110). Another example of playing multimedia contents other than above mentioned is a virtual jog shuttle, featuring; a temporary fast forward upon the contact with touch screen is maintained and slightly moved to the right (sensing direction); a skip of 50 secs upon the contact is moved 50 pixel to the right (sensing distance) or; a 4× fast playback upon the contact is quickly moved to the right (sensing speed), etc.

As an extend example of simulating a virtual jog shuttle, each video frame can be played separately with the manipulation of the user interface (120). Whenever the contact point moves a certain distance along the interface (120) (i.e. Drag), each frame of the video can be played separately from the previous frame to the next, or vice versa. Of course, a certain manipulation may need to be proceeded in advance to enable above mentioned functions.

The user interface (120) can also simulate a scroll bar when touch & drag is detected along the boundary of the curve shape. During the touch & drag, the focus can be switched among various lines of text or images according to the moving direction of the contact point.

FIG. 2 illustrates the input method of mobile device equipped with a touch screen in accordance with the embodiment of the present invention that relates to controlling multimedia contents play. And the control part (130) processes the input through the user interface (120).

When the contact point moves to one direction of the interface while the contact maintained on the interface (120) (i.e. Touch and Drag), the control part (130) controls the playback speed and/or direction of the multimedia contents. As illustrated in FIG. 2, the fast forward and rewind is located at the bottom right and the top left areas of the user interface (120), respectively. As the contact point of user's thumb moves to the bottom right, playing speed or fast forwarding speed shall be controlled faster. If user's thumb moves to the top left, the rewinding speed shall be faster. Furthermore, playing speed shall be normal when contact of user's thumb is off the touch screen.

The repetitive play function for the multimedia contents can be set by manipulating the user interface (120). To illustrate on how to set the starting and ending blocks for repetitive playbacks, a user can touch a section that represents the starting block located on the user interface (120), then drag along the interface (120) to another location that represents the ending block while maintaining the touch on the screen. For example, the illustration of FIG. 2 shows the playback of 10 hour long multimedia contents where a user has moved the contact point about 20% toward the bottom right after contacting the top left portion of the interface (120) using his thumb. On the top left of the interface (120), it is indicated as 2:03:34 meaning that the current location of playback is at 2 hours 3 minutes and 34 seconds from the start. When user takes off his thumb after that, section repetition is set from the start of multimedia contents to 2 hours 3 minutes and 34 seconds. Of course, a certain manipulation may need to be proceeded to enable above mentioned the section repetition function.

One or more buttons (140) to control each function of the mobile device can be equipped. Such soft buttons (140) are displayed on the touch screen (110) within the user interface (120). As illustrated in FIG. 2, the buttons related to multimedia playback such as reverse play, pause, volume control are displayed on touch screen (110), but there is no restriction in function or shape for buttons as long as they are related to the manipulation of the mobile device.

### Mode for the Invention

FIG. 3 illustrates the method of menu selection and navigation for the mobile device equipped with a touch screen utilizing the present invention. The focus can be switched among various selections that are displayed on the touch screen (110) as the contact point is moved along the interface (120) while the contact maintained. As illustrated in FIG. 3, the focus has been moved from “Movie Title 01” to “Movie Title 04” as left thumb of a user moved from top left to right while touching the interface (120) of the touch screen (120).

1. A mobile device equipped with a touch screen comprising:
A touch screen;
An arc-shaped user interface, displayed on the touch screen, which takes one corner of the touch screen as its center; and
A control part that performs the processes corresponding to the contact on the user interface when contact and movement is detected on the user interface.

2. The mobile device equipped with a touch screen as claimed in claim 1, wherein the radius of the interface is between 2 to 6 cm.

3. The mobile device equipped with a touch screen as claimed in claim 1, wherein the control part performs the process corresponding to the coordinates of contact point when contact and movement on the user interface is detected.

4. The mobile device equipped with a touch screen as claimed in claim 1, wherein the control part performs the process according to moving direction and/or moving distance and/or moving speed in case the contact point was moved with contact still maintained on the interface.

5. The mobile device equipped with a touch screen as claimed in claim 1, wherein in the control part moves the focus among selections displayed on the touch screen in case the contact point was moved with contact maintained on the interface along the predefined area of the user interface.

6. A mobile device equipped with a touch screen comprising:
A touch screen;
An arc-shaped user interface, displayed on the touch screen, which takes one corner of the touch screen as its center; and
A control part that controls the playback of multimedia contents wherein the control part controls the playback speed and direction of multimedia contents according to the direction, distance and speed of the user's thumb movement when the contact is maintained on the touch screen along the predefined area of the user interface.

7. The mobile device equipped with a touch screen as claimed in claim 6, wherein the control part controls the speed and/or the direction of the playback according to the the direction of user's thumb movement while the touch maintained on the user interface, and controls the speed and/or the direction of the playback at normal speed and/or direction as soon as the contact on the user interface is detected to be off.

8. The mobile device equipped with a touch screen as claimed in claim 6, wherein the control part plays back repeatedly the corresponding section of the multimedia contents after the contact point is moved from one point to another along the predefined area of the user interface.

9. The mobile device equipped with a touch screen as claimed in claim 6, wherein the control part plays each frame of the video separately from the previous frame to the next or vice versa, whenever the contact point moves a certain distance along the interface.

10. The mobile device equipped with a touch screen as claimed in claim 6, wherein the soft buttons to control the mobile device are displayed within the user interface.

11. A mobile device equipped with a touch screen comprising:
A touch screen;
An arc-shaped user interface, displayed on the touch screen, which takes one corner of the touch screen as its center; and
A control part that moves the focus among selections displayed on the touch screen when the contact point is moved with contact maintained on the interface along the predefined area of the user interface.
